(19) United States
(12) Patent Application Publication
(10) Pub. No.: US 2013/0288007 A1
(43) Pub. Date: Oct. 31, 2013

(54) METHODS AND APPARATUS FOR CASTING SOL-GEL WAFERS

(71) Applicant: NANOTUNE TECHNOLOGIES CORP., Mountain View, CA (US)

(72) Inventors: Shiho WANG, Sunnyvale, CA (US); Jaspal SINGH, San Jose, CA (US); Yudi YUDI, Alameda, CA (US)

(73) Assignee: NANOTUNE TECHNOLOGIES CORP., Mountain View, CA (US)

(21) Appl. No.: 13/870,909

(22) Filed: Apr. 25, 2013

Related U.S. Application Data
(60) Provisional application No. 61/638,404, filed on Apr. 25, 2012.

(51) Int. Cl. B28B 3/00

(52) U.S. Cl. CPC B28B 3/00
USPC 428/156; 425/110; 264/241; 428/221; 428/220

(57) ABSTRACT

A mold for casting sol-gel wafers is provided. The mold may be formed of multiple low-friction layers, for example, layers made of polytetrafluoroethylene (e.g., Teflon™). The layers may alternate between solid layers and well layers, with a gel formulation placed in wells of each well layer. A force may be applied to the layers during the gelling process to produce a solid, but wet and porous gel in the shape of the wells of the mold. The gel may be further processed to produce sol-gel derived monoliths having desired surface characteristics.

### CROSS-REFERENCE TO RELATED APPLICATIONS

This application claims the benefit of U.S. Provisional Application No. 61/638,404, filed Apr. 25, 2012, which is hereby incorporated by reference in its entirety.

### BACKGROUND

1. Field

The present disclosure relates generally to sol-gel derived monoliths, and more particularly, to methods and apparatus for making sol-gel wafers.

2. Related Art

Generally, a sol-gel process starts by forming a colloidal solution (a “sol” phase), and hydrolyzing and polymerizing the sol phase to form a solid, but wet and porous, “gel” phase. The gel phase can be dried monolithically in a controlled manner, but not under supercritical conditions, so that fluid is removed to leave behind a dry monolithic matrix having an open network of pores (a xerogel). The term “xerogel” as used herein is meant to refer to a gel monolith that has been dried under nonsupercritical temperature and pressure conditions. Alternatively, the gel phase can be dried under supercritical conditions to form a low density gel monolith that is referred to as “aerogel.” The dry gel monolith can then be calcined to form a solid glass-phase monolith with connected open pores. The dry gel monolith can be further densified, e.g., sintered, at elevated temperatures to convert the monolith into a porous or nonporous ceramic or glass, e.g., for forming oxide-based coatings or fibers for optical applications.

Dry gel monoliths may also be used, for example, as electrodes in fuel cells, batteries, or capacitors, such as electric double-layer capacitors, as described in U.S. Patent Application Publication No. 2009/0303660 and PCT WO 2009/152239 entitled “Nanoporous Electrodes and Related Devices and Methods”, which are hereby incorporated by reference in their entirety and for all purposes as if put forth in full below.

In forming the dry gel monolith for these and other applications, it is desirable that the monoliths have a uniform thickness throughout the monolith as well as have uniform thicknesses between monoliths. Methods have been developed to form such dry gel monoliths, however, current methods are slow, not scalable, and produce non-uniform dry gel monoliths.

Thus, improved methods and apparatus for forming sol-gel derived monoliths are desired.

### BRIEF SUMMARY

A mold for casting sol-gel wafers and methods of using the mold are provided. The mold may be formed of multiple hydrophobic low-friction layers, for example, layers made of polytetrafluoroethylene (e.g., Teflon™). The layers may alternate between solid layers and well layers, with a gel formulation placed in wells of each well layer. A force may be applied to the layers during the gelling process to produce a solid, but wet and porous gel in the shape of the wells of the mold. The gel may be further processed to produce sol-gel derived monoliths having desired surface characteristics. In some embodiments, the sol-gel is further dried to produce a dry gel monolith such as a xerogel or an aerogel.

In some embodiments, the disclosure provides an apparatus for forming sol-gel derived monoliths, the apparatus comprising: a first separating layer; a first well layer disposed on the first separating layer, the first well layer having at least one well; and a second separating layer disposed on the first well layer opposite the first separating layer, wherein the at least one well is covered by the first separating layer and the second separating layer. In some embodiments, the apparatus comprises a plurality of alternating separating layers and well layers, for example, 2, 5, 10, 15, 20, 25, 30, 35, 40, 50, 75, 100, 200, 300, 400, 500, or more well layers and the appropriate number of separating layers disposed on and between the well layers. In some embodiments, each well layer comprises multiple wells, for example, 2, 3, 4, 5, 6, 7, 8, 9, 10, 11, 12, 13, 14, 15, 16, 20, 25, or more wells per well layer. In some embodiments, the well is filled with a gel formulation comprising a SiO₂ precursor (such as tetraalkylorthosilicates), water, and a catalyst. In some embodiments, the well is filled with a gel formulation comprising one or more organic monomers (such as furfuryl alcohol, or a phenolic compound and formaldehyde), water, and optionally a catalyst.

In some embodiments, the disclosure provides a method of forming sol-gel derived monoliths, the method comprising: inserting alternating separator and well layers into a container containing a gel formulation; applying pressure to the stack of layers; and allowing the gel formulation to form a gel. In some embodiments, the method further comprises removing pressure once the gel formulation has gelled; and processing the gel to form a dry gel monolith (a wafer) in the container. In some embodiments, the method allows for formation of a plurality of sol-gel derived monoliths simultaneously. In some embodiments, the gel formulation used comprises a SiO₂ precursor and the gel monolith formed is a silica gel monolith. In some embodiments, the gel formulation used comprises carbon polymer precursors and the gel monolith formed is a carbon gel monolith. In some embodiments, the gel formulation used comprises a SiO₂ precursor and carbon polymer precursors and the gel monolith formed is a co-polymer gel monolith. In some embodiments, the gel formulation used may further comprises a SiO₂ precursor and carbon polymer precursors plus metal salts such as nickel chloride, cobalt (III) chloride, manganese nitrate, iron(III) chloride and the like, and the gel monolith formed is a metal containing co-polymer monolith.

In some embodiments, the disclosure provides dry sol-gel monoliths that have substantially uniform dimensions. In some embodiments, the dry sol-gel monoliths are wafers having a thickness of about 300 μm or less, about 250 μm or less, about 200 μm or less, about 150 μm or less, about 120 μm or less, about 100 μm or less, about 75 μm or less, or about 50 μm or less. In some embodiments, the sol-gel wafers have a thickness of about 300 μm to about 25 μm, about 250 μm to about 25 μm, about 200 μm to about 50 μm, about 150 μm to about 50 μm, about 120 μm to about 50 μm, about 120 μm to about 80 μm, or about 75 μm to about 25 μm. In some embodiments, the sol-gel wafers have a thickness of about 300 μm, about 250 μm, about 200 μm, about 150 μm, about 120 μm, about 100 μm, about 80 μm, about 50 μm, or about 25 μm. In some embodiments, the thickness of a sol-gel wafer across different portions may vary by less than 10%, less than 5%, less than 3%, less than 2%, or less than 1% of the thickness. In some embodiments, a plurality of sol-gel wafers are produced simultaneously, such as 5 or more, 10 or more, 20 or more, 50 or more, 100 or more, 200 or more, 500 or more, 1000 or more, 5000 or more, 10,000 or more, 20,000 or more, 50,000 or more, 100,000 or more, or 500,000 or more sol-gel wafers may be produced simultaneously or in one batch. In some embodiments, the thickness of individual sol-gel wafers in a batch may vary by less than 10%, less than 5%, less than 3%, less than 2%, or less than 1% from one wafer to another. In some embodiments, the sol-gel wafers are produced according to the methods for forming sol-gel derived monoliths described herein or by using the apparatus for forming sol-gel derived monoliths described herein.

### BRIEF DESCRIPTION OF THE DRAWINGS

FIG. 1 illustrates an exemplary separator sheet for use in a mold for forming gel derived monoliths.

FIG. 2 illustrates an exemplary well sheet for use in a mold for forming gel derived monoliths.

FIG. 3 illustrates an exemplary mold comprising separator sheets and well sheets for forming gel derived monoliths.

FIG. 4 illustrates another exemplary mold comprising separator sheets and well sheets for forming gel derived monoliths.

FIG. 5 illustrates an exemplary container for forming gel derived monoliths.

FIG. 6 illustrates an exemplary cover for use with the exemplary container shown in FIG. 5.

FIG. 7 illustrates an exemplary container, mold, and cover for forming gel derived monoliths.

FIG. 8 illustrates an exemplary filler for use with the exemplary container shown in FIG. 5.

FIG. 9 illustrates an exemplary process for making a dry gel monolith.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Various embodiments are described below relating to molds for forming sol-gel derived monoliths having a desired shape and configuration. The mold may be formed of multiple hydrophobic and low-friction layers, for example, layers made of polytetrafluoroethylene (PTFE, e.g., Teflon™) or polymethylpentene (PMP, e.g. TPX® PMP). The layers may alternate between solid layers and well layers, with a gel formulation placed in wells of each well layer. A force may be applied to the layers during the gelling process to produce a solid, but wet and porous gel in the shape of the wells of the mold. The gel may be further processed (e.g., within the mold) to produce sol-gel derived monoliths having desired surface characteristics. Optionally, the sol-gel may be further dried under controlled non-supercritical conditions to form a xerogel or dried under supercritical conditions to form an aerogel.

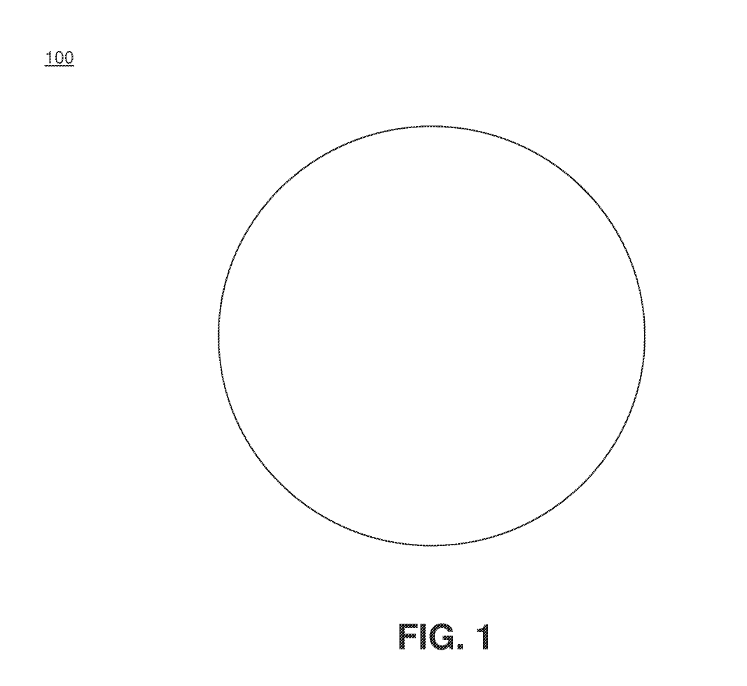

FIG. 1 illustrates an exemplary separator sheet 100 for use in a mold for forming sol-gel derived monoliths. Separator sheet 100 may comprise any hydrophobic material having a low coefficient of friction (static and kinetic) and low surface tension, for example, polytetrafluoroethylene (e.g., Teflon™) or polymethylpentene (e.g. TPX® PMP), which has a surface tension of about 20 and 24 dyne/cm respectively. However, other hydrophobic materials now known, or later developed, having low friction (static and kinetic) coefficients and low surface tension may be used. In one example, the material used for separator sheet 100 may have a coefficient of friction (static and kinetic) in the range of 0.0-0.2. In another example, the material used for separator sheet 100 may be chemically resistant to those chemicals used in the gelling process, high-temperature resistant (e.g., resistant to 160° C. or above), and hydrophobic. Further, the surface of separator sheet 100 may be treated or conditioned so as to impart a desired surface quality to the molded monolith, e.g., hydrophobically treated. For example, the separator sheet 100 surface may be chemically cleaned, physically cleaned, and/or have static charges removed. Commercial PTFE products may be used, such as TEFNAT0.010 and TEFNAT0.020 from Ridour Plastic, including PTFE rolls or sheets of 12 inch or more in width and 1 foot to 12 feet, 24 feet or more in length. TPX® Polymethylpentene (PMP) from Mitsui Chemicals may be also be used (http://jp.mitsuichem.com/info/tpx/etpx/eindex.html).

In one example, separator sheet 100 may be cut into a circular sheet having a diameter of approximately 5 inches. Additionally, separator sheet 100 may have a thickness ranging from 80-600 μm. For example, separator sheet 100 may have a thickness of approximately 125 μm, 250 μm, or 500 μm. Separator sheet 100 may have a uniform thickness across the sheet, or at least a substantially uniform thickness across the sheet. For example, the thickness of the sheet across different portions of the sheet may vary by less than 10%, less than 5%, less than 3%, less than 2%, or less than 1% of the thickness. In one example, separator sheet 100 may be formed by placing a pattern over a sheet of separator sheet material and cutting around the pattern. In another example, a press, such as a die cutter, maybe used to punch holes into a sheet of separator sheet material to form separator sheet 100. In yet another example, a laser may be used to cut a sheet of separator sheet material to form separator sheet 100. A preferred method to obtain well sheets with smooth edges is by knife drill cutting. A stack of tightly bond PTFE thin films is drilled into any desired shapes and dimensions of separator sheets well sheets and the well, for example, using an Easy Track 3-Axis CNC milling machine made by Bridgeport. However, one of ordinary skill will appreciate that other methods of cutting a sheet of material to form separator sheet 100 may be used. Additionally, while specific shapes and sizes of separator sheet 100 have been provided above, it should be appreciated by one of ordinary skill that other shapes and sizes may be used depending on the desired application.

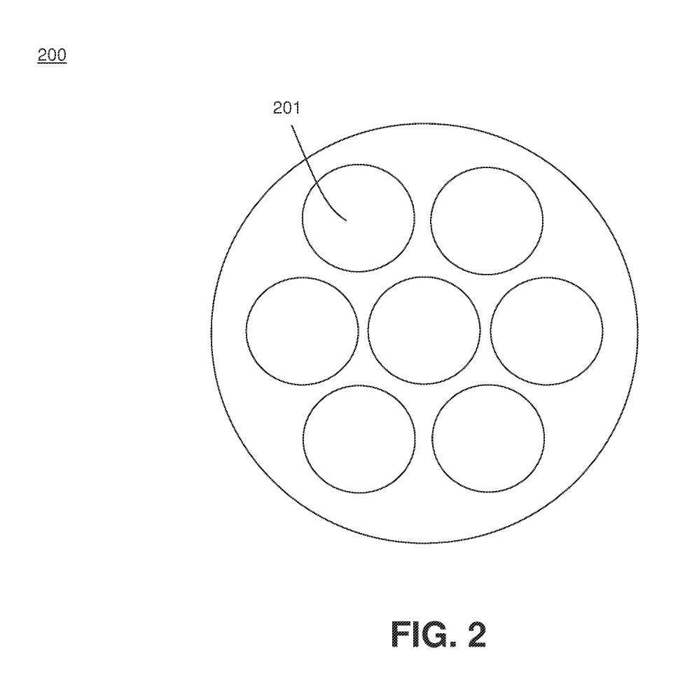

FIG. 2 illustrates well sheet 200 for use in a mold for forming sol-gel derived monoliths. Well sheet 200 may comprise the same, similar, or a different material as separator sheet 100. In one example, well sheet 200 may be made of polytetrafluoroethylene (e.g., Teflon™). Additionally, well sheet 200 may be cut to have the same or similar shape as separator sheet 100. In one example, well sheet 200 may be a circular sheet having a diameter of approximately 5 inches. Well sheet 200 may have a thickness ranging from 80-600 μm. For example, well sheet 200 may have a thickness of approximately 125 μm, 250 μm, or 500 μm. Well sheet 200 may have a uniform thickness across the sheet, or at least a substantially uniform thickness across the sheet. For example, the thickness of the sheet across different portions of the sheet may vary by less than 10%, less than 5%, less than 3%, less than 2%, or less than 1% of the thickness.

Well sheet 200 may include wells 201 for molding sol gel monoliths. Wells 201 may be formed by removing portions of well sheet 200 using known cutting methods. In one example, wells 201 may be cut into the shape of a circle have a diameter between 20-50 mm. In another example, well 201 may be cut into the shape of a circle having a diameter of approximately 34 mm. In one example, well sheet 200 may be formed by removing material from a separator sheet 100. For example, wells 201 may be cut by placing a pattern over a separator sheet 100 and cutting around the pattern. In another example, a press, such as a die cutter, maybe used to punch holes into a separator sheet 100 to form wells 201. In yet another example, a laser may be used to cut a separator sheet 100 to form wells 201. One of ordinary skill in the art will appreciate that other methods of cutting a sheet to form well sheet 200 having wells 201 may be used so long as the method produces smooth inner edges of wells 201. If the inner edges of wells 201 are not smooth, the sol-gel may attach to the rough edges and may break as the gel shrinks during the drying process.

While specific shapes and sizes of well sheet 200 and wells 201 have been provided above, it should be appreciated by one of ordinary skill that other shapes and other sizes may be used depending on the desired application. For example, as explained in greater detail below, a gel formulation may be molded into a desired form by placing and storing the gel formulation in each well 201. Thus, the shape and size of the resulting dry gel monolith is based in part on the shape and size of well 201. Further, the inner edges of wells 201 form the sidewalls of the mold, and thus the thickness of the resulting dry gel monolith is based in part on the thickness of well sheet 200. Depending on the gel formulation used, the gel formulation may shrink during the drying process. The amount that the gel formulation shrinks may be used in determining the desired shape, thickness, and size of well sheet 200 and wells 201. In some embodiments, the gel formulation shrinks to approximately 60% to approximately 40% of its original size during the drying process. For example, for a gel that shrinks to approximately 40% of its original size during the drying process, a well sheet having a thickness of 500 μm may be used to generate a dry gel monolith having a thickness of 200 μm. Additionally, since well sheet 200 has a substantially uniform thickness, for example, the thickness of the sheet across different portions of the sheet may vary by less than 10%, less than 5%, less than 3%, less than 2%, or less than 1% of the thickness, the resulting dry gel monolith also has a substantially uniform thickness. For example, the thickness of the dry gel monolith across different portions of the monolith may vary by less than 10%, less than 5%, less than 3%, less than 2%, or less than 1% of the thickness.

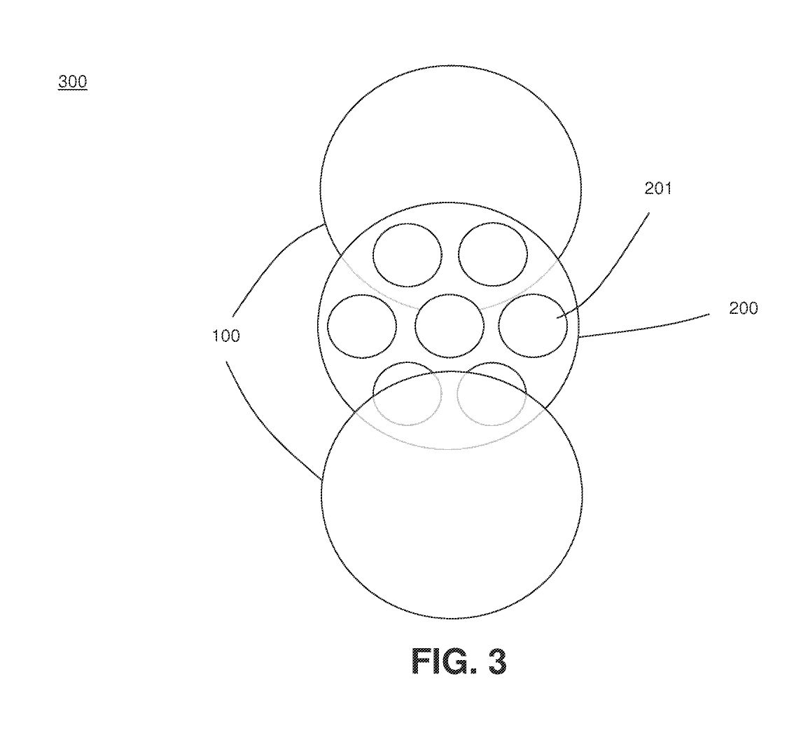

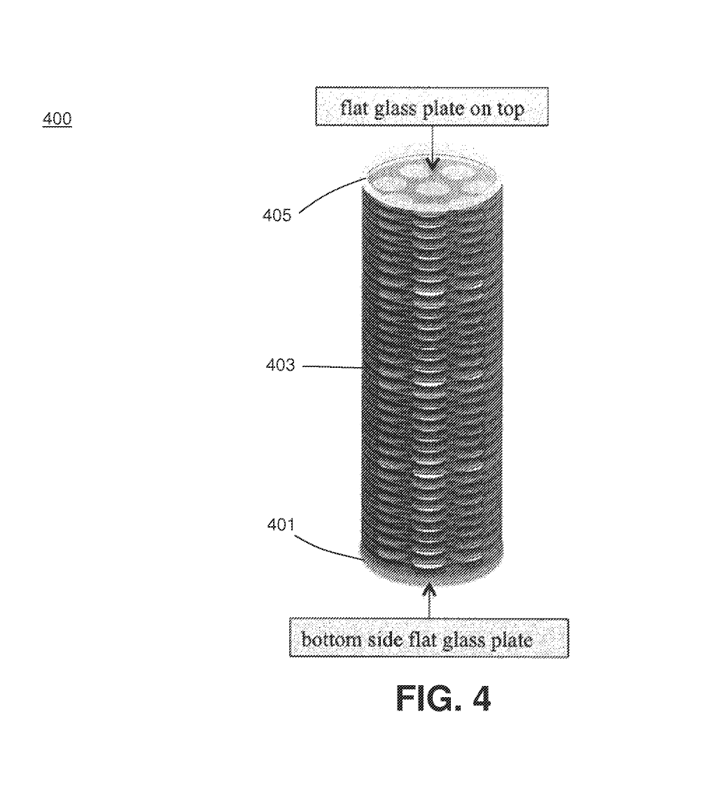

FIG. 3 illustrates an exploded view of mold 300 comprising separator sheets 100 and well sheet 200 for forming sol-gel monoliths. As shown in FIG. 3, mold 300 may include a first separator sheet 100 placed below a well sheet 200. The first separator sheet 100 acts as a base for mold 300 with well sheet 200 forming the wells of mold 300. The wells of mold 300 formed by wells 201 may be used to hold a gel formulation and to mold the formulation into a dry gel monolith. Mold 300 may further include a second separator sheet 100 placed above well sheet 200. The second separator sheet 100 acts as a cover for mold 300. As stated above, FIG. 3 illustrates an exploded view of mold 300. In operation, separator sheets 100 and well sheet 200 may be stacked in a manner such that each layer covers the layer below, for example, as shown in FIG. 4.

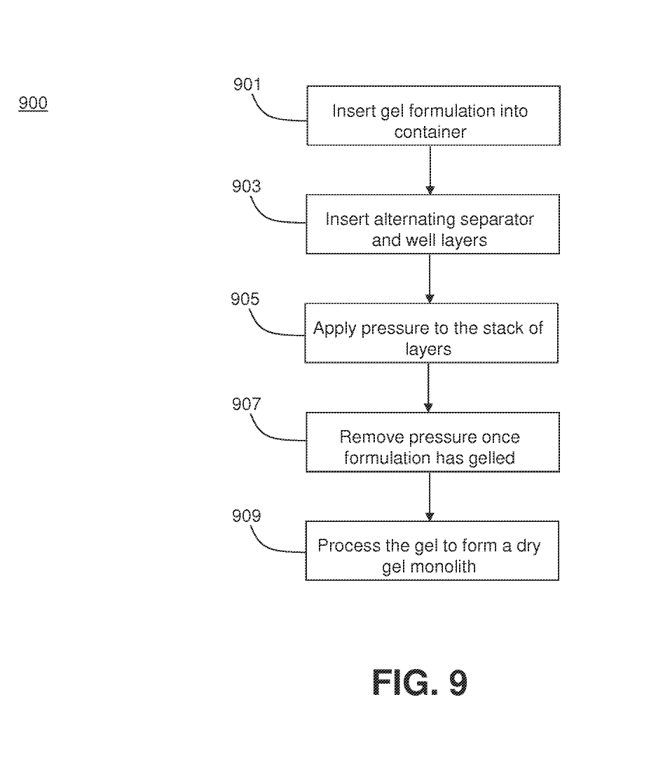

In one example, pressure may be applied to one or both sides of mold 300 (applied to separator sheets 100) to force excess gel formulation out and away from each well 201 and to mold the remaining gel formulation into the shape of wells 201. In one example, where separator sheets 100 and well sheet 200 may have 5 inch diameters, a pressure in the range of 100-150 lbs may be applied. This pressure may be applied to the mold for a sufficient time to allow the gel formulation to become a solid, but wet and porous gel. After the gel forms, the pressure may be removed. Methods for using a mold similar to mold 300 will be described in greater detail below with respect to FIG. 9.

In another example, mold 300 may further include a solid sheet placed on either side of mold 300 to flatten the top and bottom surfaces and to evenly distribute pressure across the top and bottom surfaces. For example, a sheet of glass may be placed against one or both separator sheets 100 of mold 300 and pressure may be applied to one or both sheets of glass.

FIG. 4 illustrates a stacked mold 400 comprising multiple separator sheets 100 and well sheets 200 for forming sol-gel monoliths. Stacked mold 400 may include multiple alternating layers 403 of separator sheets 100 and well sheets 200 forming multiple molds similar to that described above with respect to FIG. 3. In one example, stacked mold 400 may include a hard surface, such as a glass plate 401, placed at the bottom of stacked mold 400. Stacked mold 400 may further include alternating layers 403 of separator sheets 100 and well sheets 200 stacked on glass plate 401. Specifically, a first separator sheet 100 may be placed on glass plate 401, forming the base of the first mold. A first well sheet 200 may be placed above the first separator sheet 100 to form the sidewalls of the wells of the first mold. A second separator sheet 100 may be placed over the first well sheet 200 to form the cover of the first mold. The second separator sheet 100 may further act as the base of the second mold. For instance, a second well sheet 200 may be placed over the second separator sheet 100 to form the sidewalls of the wells of the second mold. A third separator sheet 100 may be placed on the second well sheet 200 to form the cover of the second mold. Separator sheets 100 and well sheets 200 may be placed in this alternating fashion any number of times to form any number of molds. In one example, a solid flat surface, such as glass plate 405, may be placed above the last separator sheet 100 of stacked mold 400. Pressure may be applied to one or both ends (top or bottom) of stacked mold 400 until the gel formulation becomes a gel.

In one example, wells 201 of each well sheet 200 may be aligned above each other in stacked mold 400. This arrangement forces the pressure applied to stacked mold 400 to be distributed along the solid portions of well sheets 200. The result is a more stable structure that avoids excessive pressure at the locations of wells 201.

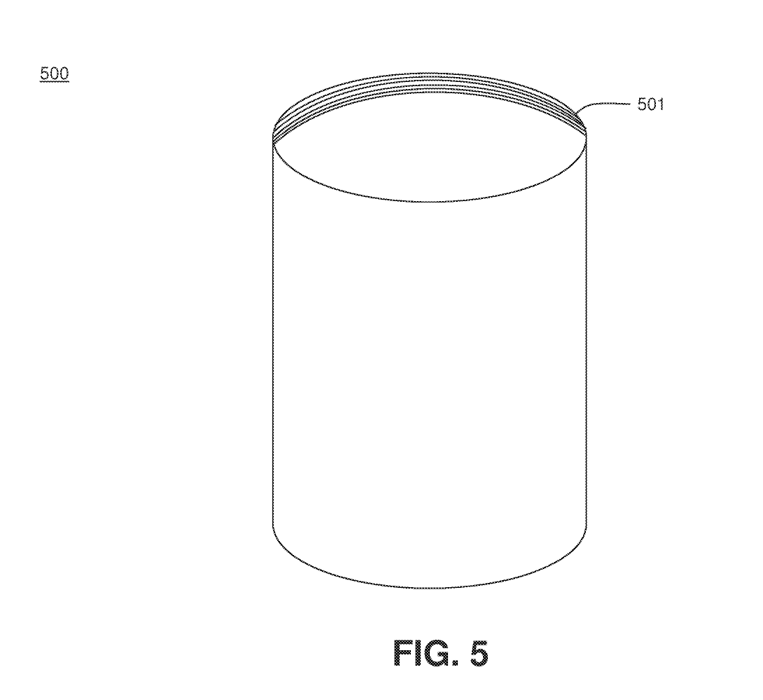

FIG. 5 illustrates an exemplary container 500 for holding stacked mold 400. Container 500 may be made of the same, similar, or different material as separator sheets 100 and well sheets 200. In one example, container 500 may be made of polytetrafluoroethylene (e.g., Teflon™). Container 500 may have an inner diameter slightly larger than the diameter of separator sheets 100 and well sheets 200 to allow excess gel formulation and gasses to escape from between the sheets. For example, when separator sheets 100 and well sheets 200 have 5 inch diameters, container 500 may have an inner diameter of 5⅛ inches. While container 500 is shown as a cylinder, it should be appreciated that container 500 may be formed into other shapes and sizes depending on the shape and size of separator sheets 100 and well sheets 200. The shape of the container, separator sheets, and well sheets can be rectangular. The container's inner dimensions must be slightly larger than the separator sheets 100 and well sheets 200 to allow excess solution and gasses to get out of stacked sheets when pressure is applied or during heat treatment.

In one example, container 500 may be used to hold stacked mold 400 during the gelling and drying process. The operation of container 500 will be described in greater detail below with respect to FIG. 9.

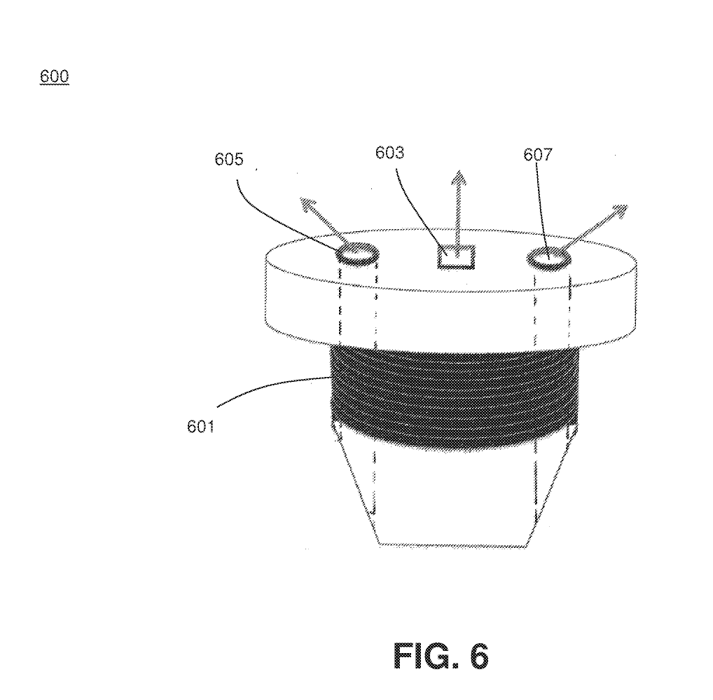

In another example, container 500 may be used to apply pressure to stacked mold 400 using a pressure cap, such as pressure cap 600 shown in FIG. 6. In this example, container 500 may include threads 501 for mating with threads 601 of pressure cap 600. In another example, container 500 may be configured to allow a weight to be placed on stacked mold 400 for exerting the required pressure on the mold during the gelling process. Or, after certain amount of weight/pressure is applied onto the stacked mold, a clamp system can be used to hold the pressure, then the weight can be removed from the stacked mold.

In yet another example, container 500 may further include guideposts (not shown) extending up from the base of the container for aligning wells 201 of well sheets 200 as described above. In one example, holes may be placed in each of the separator sheets 100 and well sheets 200 to allow each sheet to be slid into place down the guideposts.

FIG. 6 shows exemplary pressure cap 600 for applying pressure to a stacked mold 400 within container 500. Pressure cap 600 may include threads 601 for mating with threads 501 of container 500. Pressure cap 600 may further include a socket 603 for receiving a male counterpart of a torque wrench. Using socket 603 and a torque wrench, pressure cap 600 may be tightened until a desired pressure is applied to stacked mold 400. Socket 603 may also act as a vent to allow vapor to escape from container 500 when it is sealed. In one example, container 500 may have a height of 12 inches or larger to allow stacked mold 400 to be placed inside. For example, container 500 may be between 12 and 15 inches tall. In one example, when a stacked mold 400 having a diameter of approximately 5 inches and a height of 12 inches is used, between 100-200 lbs of pressure may be applied using pressure cap 600. While specific dimensions and pressures are described above, one of ordinary skill will appreciate that other dimensions, and thus other pressures, may be used.

In another example, pressure cap 600 may further include vents 605 and 607 for allowing vapor to escape from container 500. In yet another example, one or more of vents 605 and 607 may allow gas to be pumped into container 500, for example, to purge residual gasses from the container during the drying process.

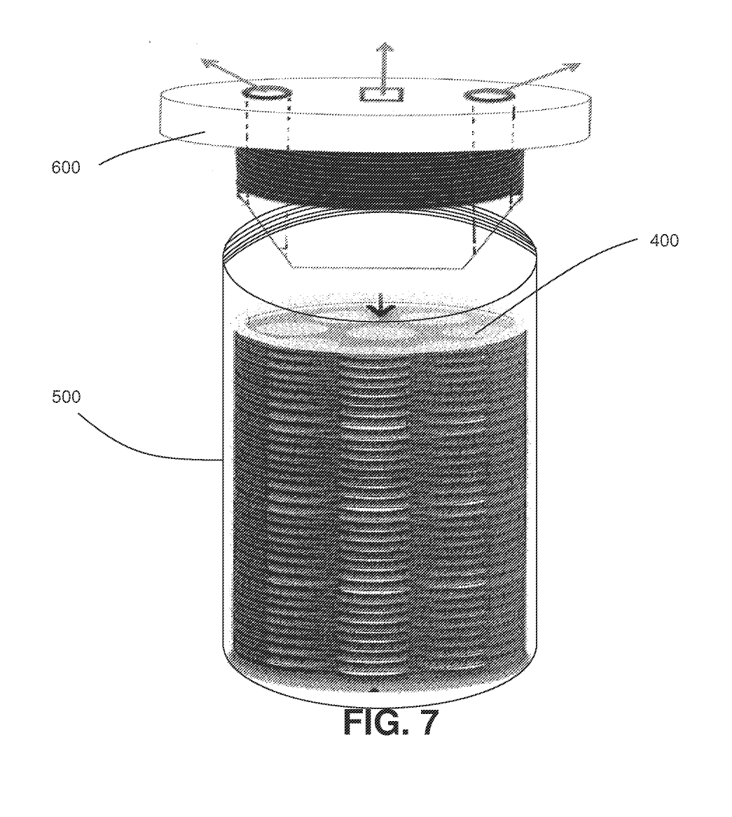

FIG. 7 illustrates the assembly of container 500, stacked mold 400, and pressure cap 600 as discussed above.

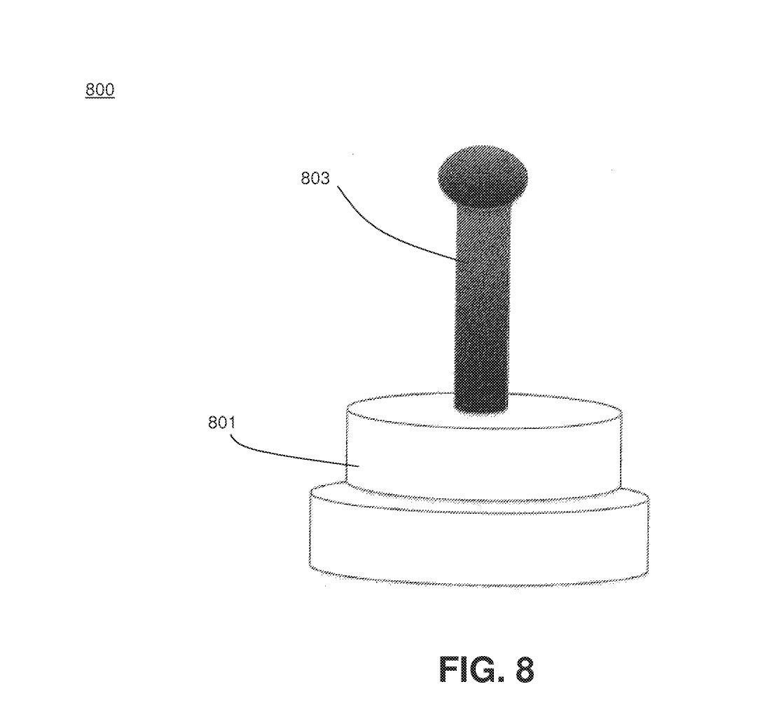

FIG. 8 illustrates an exemplary filler 800 for compensating for any gaps between stacked mold 400 and pressure cap 600. For instance, in one example, pressure cap 600 may have a set height and may only be lowered into container 500 to a certain point. Thus, if the top of stacked mold 400 is lower than this point, pressure cap 600 will not be able to contact stacked mold 400, and therefore cannot exert any pressure on the mold. Thus, the bottom portion 801 of filler 800 may be inserted between the top of stacked mold 400 and the bottom of pressure cap 600 to allow pressure cap 600 to exert a force on stacked mold 400 via the filler. The bottom portion 801 of filler 800 may be made of any solid material, such as polytetrafluoroethylene (e.g., Teflon™) or its derivative materials. However, other materials that are chemically resistant to those chemicals used in the gelling process, high-temperature resistant (e.g., resistant to 160° C. or above), flat and rigid, may be used.

In one example, filler 800 may include a detachable handle 803 for depositing the bottom portion 801 of filler 800 on top of stacked mold 400.

In another example, as an alternative to pressure cap 600, a weight may be placed on top of stacked mold 400 for exerting the desired pressure on the mold. In one example, the weight may be designed similar to filler 800 in that a detachable handle may be used to place the weight on stacked mold 400. It will be appreciated by one of ordinary skill that other methods of applying pressure to stacked mold 400 may be used.

FIG. 9 illustrates an exemplary process 900 for forming a dry gel monolith. At block 901, a container identical or similar to container 500 may be filled with a gel formulation. At block 903, alternating layers of separator layers 100 and well layers 200 may be placed in the container to form a stacked mold 400. In one example, a separator layer 100 may be placed at the bottom of container 500 on a glass plate with alternating layers of well layers 200 and separator layers 100 placed above. The layers may be added one at a time to allow the gel formulation in container 500 to sufficiently fill each well 201 before being covered by the subsequent separator layer 100. In another example, the alternating layers may be placed in container 500 using guideposts to align the wells 201 of each well layer 200. At block 905, pressure may be applied to the stacked mold 400. In one example, pressure may be applied using a pressure cap identical or similar to pressure cap 600 discussed above. In another example, a weight may be placed on stacked mold 400. The pressure may be applied to stacked mold 400 until the gel formulation has gelled. At block 907, after the gel formulation has gelled, the pressure may be removed from stacked mold 400. At block 909, the gelled sol may be monolithically dried to form a dry gel monolith. For instance, this may be done by placing container 500 and stacked mold 400 in a drying oven. Additionally, the gelled sol may be further processed to produce a surface having desired characteristics. Drying processes and methods for producing dry gel monoliths with desired surface characteristics are described in greater detail in U.S. Patent Application Publication No. 2009/0305026 and PCT WO 2009/152229 entitled “Nanoporous Materials and Related Methods”. Other drying processes and methods known in the art may also be used. See, e.g., U.S. Pat. Nos. 4,851,150; 4,849,378; 5,264,197; 6,884,822; 7,001,568; 7,125,912; and PCT WO 2006/068797.

Dry gel monoliths and processes for making dry gel monoliths are described in detail, for example, in U.S. Patent Application Publication No. 2009/0305026 and PCT WO 2009/152229 entitled “Nanoporous Materials and Related Methods”, which are hereby incorporated by reference in their entirety and for all purposes as if put forth in full below. The various embodiments described herein may be used to mold the same or similar gel formulations into dry gel monoliths having a desired shape, size, and configuration. While the various embodiments are described below with respect to forming sol-gel derived monoliths, it should be appreciated that the various embodiments may be applied to other gels where is it desired to mold the gel into a particular shape and configuration.

In some embodiments, a gel formulation comprises a SiO₂ precursor, water, and a catalyst. The SiO₂ precursor may comprise an alkylorthosilicate (e.g., tetramethylorthosilicate or tetraethylorthosilicate). The SiO₂ precursor may be mixed with the water and the catalyst to form a sol with or without a solvent (e.g., an alcohol). The catalyst may comprise a mixture of hydrofluoric acid and a second acid. The second acid includes, but is not limited to, a strong acid (e.g., HCl, H₂SO₄, HNO₃, etc.), a weak acid (e.g., citric acid, acetic acid, formic acid, etc.), and an organic acid. Any molar ratio of the SiO₂ precursor, water, and the catalyst described in U.S. Publication No. 2009/0305026 and WO PCT 2009/152229 or known in the art that allows formation of a desired sol-gel may be used.

The microstructure (such as the average pore size or the pore size distribution) of a silica sol-gel derived monolith may be controlled by varying any one or any combination of several reaction parameters, such as the ratios of the SiO₂ precursor, water, and the catalyst, the acidity (pKₐ) of the acid catalyst, and the temperature or temperature profile used in the hydrolysis and polymerization process. The SiO₂ precursor may be hydrolyzed under either nonstoichiometric or stoichiometric hydrolysis conditions. In some variations, the molar ratio of water to precursor is about 3:1 or less, about 2.5:1 or less, about 2.25:1 or less, or about 2:1. In some variations, hydrolysis is performed directly with water and with no solvent (such as an alcohol, including methanol and ethanol) added into the reaction. In some embodiments, the catalyst may comprise hydrofluoric acid (or suitable fluorine-containing compounds that can produce HF during hydrolysis, or during polymerization) and a second acid. In some variations, when a stoichiometric amount of water relative to a precursor (about 4:1) is used, a molar ratio of HF to precursor that is about 0.01:1 or less may be used, for example, about 0.01:1, about 0.009:1, about 0.008:1, about 0.007:1, about 0.006:1, about 0.005:1, about 0.004:1, about 0.003:1, about 0.002:1, about 0.001:1, about 0.0005:1, or even less, and in some cases no HF may be used. In some variations, when a non-stoichiometric amount of water relative to a precursor is used, for example, 2.25 moles of water relative to one mole of a precursor such as TEOS or TMOS, the molar ratio of HF to the precursor used in the methods may be about 0.1:1, about 0.09:1, about 0.085:1, about 0.08:1, about 0.075:1, about 0.07:1, about 0.065:1, about 0.06:1, about 0.055:1, about 0.05:1, about 0.045:1, or about 0.04:1. The second acid in these instances may be any suitable acid, for example, a strong acid such as an acid having a first pKₐ that is lower about −1 or lower, for example, HCl, H₂SO₄, HNO₃, or a combination thereof, a weak acid such as an acid having a first pKₐ that is about 2 or greater, for example, a first pKₐ of about 2 to about 5, or about 2 to about 4, for example, citric acid, acetic acid, formic acid, or a combination thereof, or an intermediate acid. Different temperatures or temperature profiles may be used, and may depend on a catalyst selected. In some situations, a temperature or temperature ramp that includes temperatures below ambient may be used for gelation, for example, as described in U.S. Pat. No. 6,884,822, which is incorporated herein by reference in its entirety. In other instances, elevated reaction temperatures may be used, which may be at least in part due to exothermic hydrolysis reaction. Reaction temperatures may range from about 0° C. to about 80° C., or from about 15° C. to about 125° C., or from about 45° C. to about 100° C.

In some embodiments, a gel formulation comprises one or more organic monomers, water, and a catalyst. The organic monomers are polymerized to form a carbon sol-gel. In some embodiments, the organic monomers are a phenolic compound (e.g., resorcinol) and formaldehyde. The phenolic compound may be reacted with formaldehyde in the presence of a base catalyst to form a polymeric gel. Suitable phenolic compounds include, but are not limited to, a polyhydroxybenzene, such as a dihydroxybenzene (e.g., resorcinol, catechol, or hydroquinone) or a trihydroxybenzene (e.g., phloroglucinol). Mixtures of two or more polyhydroxyphenols can also be used. Phenol (monohydroxybenzene) can also be used. The catalyst can be any compound that facilitates the polymerization of the sol to form a sol-gel, such as sodium hydroxide, sodium carbonate or potassium hydroxide, and the like. A preferred catalyst for the resorcinol/formaldehyde reaction is sodium carbonate.

The structure and properties of the carbon sol-gel formed may be determined by the ratios of the monomers, the catalyst and the solvent and the processing parameters. Any ratios of the materials (e.g., resorcinol/formaldehyde, resorcinol/water, or resorcinol/catalyst) suitable for formation of a desired sol-gel may be used. In some embodiments, the organic monomers for producing a carbon sol-gel are resorcinol and formaldehyde. In some embodiments, the resorcinol/formaldehyde molar ratio is from about 1:1 to about 1:3, from about 1:1 to about 1:2, from about 1:2 to about 1:3, from about 1:1.5 to about 1:2.5, or from about 1:1.8 to about 1:2.2. In some embodiments, the resorcinol/formaldehyde molar ratio is about 1:1, about 1:1.5, about 1:2, about 1:2.5 or about 1:3. In a preferred embodiment, the resorcinol/formaldehyde molar ratio is about 1:2. In some embodiments, the resorcinol/water molar ratio is from about 1:100 to about 2:1, from about 1:10 to about 1:1, from about 1:8 to about 1:4, from about 1:5 to about 1:1, or from about 1:5 to about 1:2. In some embodiments, the resorcinol/water molar ratio is about 1:8 or about 1:4. In some embodiments, the resorcinol/catalyst molar ratio is from about 10:1 to about 500:1, from about 20:1 to about 300:1, from about 50:1 to about 300:1, from about 20:1 to about 200:1, from about 50:1 to about 200:1, from about 100:1 to about 200:1, from about 20:1 to about 100:1, from about 25:1 to about 100:1, from about 50:1 to about 200:1, from about 20:1 to about 50:1, or from about 25:1 to about 50:1. In some embodiments, the resorcinol/catalyst molar ratio is about 25:1 or about 50:1. In some embodiments, the resorcinol/formaldehyde molar ratio is about 1:2, the resorcinol/water molar ratio is about 1:8 or about 1:4, and the resorcinol/catalyst molar ratio is about 25:1 or about 50:1.

In some embodiments, the gel formulation for producing a carbon sol-gel comprises furfuryl alcohol and water. In some embodiments, the polymerization reaction forming a sol-gel is initiated by heating furfuryl alcohol in water. In some embodiments, the polymerization reaction forming a sol-gel is catalyzed by an acid, such as trifluoroacetic acid, p-toluenesulfonic acid or oxalic acid.

The wafers produced using the methods described herein may have a thickness of about 300 microns or less, about 150 microns or less, about 120 microns or less, about 100 microns or less, or about 80 microns or less. Additionally, the sol-gel wafters may have a uniform thickness, or at least a substantially uniform thickness. For example, thickness of the sol-gel wafers across different portions of the wafer may vary by less than 10%, less than 9%, less than 8%, less than 7%, less than 6%, less than 5%, less than 3%, less than 2%, or less than 1% of the thickness. The wafers may be formed into any desired shape, for example, a circle, rectangle, etc. Additionally, the gel formulation placed in wells of each layer may shrink depending on the particular gel formulation used. For example, the gel formulation may shrink by about 30%, about 40%, about 50%, about 60%, or any other amount. The shrinkage may be controlled in part by the concentration of the gel formulation or the amount of water in the sol gel. As such, the thickness of each well of the mold may be selected based at least in part on the shrinkage properties of the gel formulation and the desired thickness of the wafer.

The thickness of a sol gel wafer described herein may be measured by methods known in the art, such as using a digital caliper by Mitutoyo Corp. (Code: 500-193 Model No: CD-12″ CP). The thickness of a wafer may be an average (e.g., a median, mean, or mode) of the thickness values measured at different portions of the wafer.

The sol gel wafers may be substantially flat across the wafer. For example, the peak-to-reference flatness deviation among the whole wafer is less than 10%, less than 9%, less than 8%, less than 7%, less than 6%, less than 5%, less than 4%, less than 3%, less than 2%, or less than 1% of the thickness of the wafer. The flatness of the electrode may be measured using methods known in the art, for example, using technology as applied for silicon wafers (e.g. using a Nanovea 750 system) (http://nanovea.com/Application%20Notes/WaferFlatness.pdf). Flatness may be quantified by laying the wafer on a flat platform, which serves as reference plane for the measurement. The height difference between the top surface of the wafer and the reference plane at various points are measured.

Surface roughness of the wafer may be characterized by the fluctuation in height of the wafer's surface. Surface roughness can be measured by methods known in the art, such as by using a Zeta-20 instrument (http://www.zeta-inst.com/page/zeta-20-summary). In some embodiments, the peak-to-valley surface roughness of a dried sol gel wafer is less than 10%, less than 9%, less than 8%, less than 7%, less than 6%, less than 5%, less than 4%, less than 3%, less than 2%, or less than 1% of the thickness of the wafer.

The monoliths made according to the methods described herein may have microstructure having a desired microstructure and a desired surface area for the open network of pores. As stated above, the total pore volume of a monolith may be determined using a pore size analyzer such as a Quantachrome Quadrasorb™ SI Krypton/Micropore analyzer, and the bulk density of a monolith may then be calculated using the total pore volume and the density of the material making up the framework in the monolith. The monoliths according to the methods described here may have a total pore volume of at least about at least about 0.1 cm³/g, at least about 0.2 cm³/g, at least about 0.3 cm³/g, at least about 0.4 cm³/g, at least about 0.5 cm³/g, at least about 0.6 cm³/g, at least about 0.7 cm³/g, at least about 0.8 cm³/g, at least about 0.9 cm³/g, at least about 1 cm³/g, at least about 1.1 cm³/g, at least about 1.2 cm³/g, at least about 1.3 cm³/g, at least about 1.4 cm³/g, at least about 1.5 cm³/g, at least about 1.6 cm³/g, at least about 1.7 cm³/g, at least about 1.8 cm³/g, at least about 1.9 cm³/g, at least about 2.0 cm³/g, or even higher. Thus, some monoliths may have a total pore volume in a range from about 0.3 cm³/g to about 2 cm³/g, or from about 0.5 cm³/g to about 2 cm³/g, or from about 0.5 cm³/to about 1 cm³/g, or from about 1 cm³/g to about 2 cm³/g. A porosity of the monoliths may be about 30% to about 90% by volume, e.g., about 30% to about 80%, about 40% to about 80%, or about 45% to about 75%. In some variations, the porosity may be lower than about 30% by volume or higher than about 90% by volume, e.g., up to about 95% by volume.

An average pore size (such as average pore diameter) of the pores in the open pore network formed in the monoliths described herein may be tunable of a range from about 0.3 nm to about 300 nm, about 0.3 nm to about 100 nm, about 0.3 nm to about 50 nm, about 0.3 nm to about 30 nm, or about 0.3 nm to about 10 nm. For example average pore sizes of about 0.3 nm, about 0.5 nm, about 0.8 nm, about 1 nm, about 2 nm, about 3 nm, about 4 nm, about 5 nm, about 6 nm, about 7 nm, about 8 nm, about 9 nm, or about 10 nm may be preselected and achieved using the methods described herein. For any preselected average pore size achieved in the monoliths described herein, a relatively narrow distribution around that average may be achieved. For example, at least about 50%, at least about 60%, at least about 70%, or at least of about 75% of the pores may be within about 40%, within about 30%, within about 20%, or within about 10% of an average size. In certain variations, at least about 50% of the pores may be within about 1 nm, within about 0.5 nm, within about 0.2 nm, or within about 0.1 nm of an average pore size. As used herein “within” a designated percentage or designated amount of an average pore size is meant to encompass that percentage deviation or a lesser percentage deviation, or that amount of deviation or a lesser amount of deviation to either the higher side or a lower side of the average pore size. That is, a pore size distribution that is within about 20% of an average pore size is meant to encompass pore sizes in a range from the average pore size minus 20% of that average pore size to the average pore size plus 20% of that average pore size, inclusive.

Thus, some variations of monoliths may have an average pore size that can be selected in a range from about 0.3 nm to about 300 nm, or in a range from about 0.3 nm to about 100 nm, or in a range from about 0.3 nm to about 30 nm, or in a range from about 0.3 nm to about 10 nm, and a distribution such that at least about 50% or at least about 60% of the pores are within about 20% of the average pore size, or within about 10% of the average pore size. Certain variations may have even tighter pore size distributions, e.g., monoliths may have an average pore size selectable in a range from about 0.3 nm to about 30 nm or in a range from about 0.3 nm to about 10 nm, and have a distribution such that at least about 50% of pores are within about 10% of the average. For monoliths having relatively small average pore sizes, e.g., 5 nm or smaller, e.g., about 5 nm, about 4 nm, about 3 nm, about 2 nm, about 1 nm, about 0.5 nm, or about 0.3 nm, at least 50% of the pores may be within about 1 nm, about 0.5 nm, about 0.2 nm, or about 0.1 nm of the average.

As used herein “average pore size” is meant to encompass any suitable representative measure of a dimension of a population of pores, e.g., a mean, median, and/or mode cross-sectional dimension such as a radius or diameter of that population of pores. The mean pore size, median pore size, and mode pore size of a pore size distribution in a monolith may in some cases be essentially equivalent, e.g., by virtue of a very narrow and/or symmetrical pore size distribution.

In general, the surface area of a monolith increases for smaller particles sizes, and in particular when a pore size decreases below about 3 nm, the corresponding surface area increases rapidly, e.g., exponentially or approximately exponentially. The surface area of a monolith may be measured by using the B.E.T. surface area method, or may be calculated using an average pore size as described above (Eq. 1). In general, the surface area of a monolith increases for smaller particles sizes, and in particular when a pore size decreases below about 3 nm, the corresponding surface area increases rapidly in a nonlinear manner, e.g., exponentially or approximately exponentially. There, a bulk surface area (SA) in m²/g has been calculated for versus average pore diameter (D) as described above in connection with Eq. 1. Data point symbols indicate bulk surface areas measured by B.E.T. analysis. Monoliths with dramatically increased surface areas may be prepared by the methods described herein, e.g., where the average pore size may be controlled to be about 3 nm or smaller.

As shown, as a pore size decreases from about 3 nm to about 0.6 nm, the corresponding surface area increases from about 1000 m²/g to about 5000 m²/g, e.g., a five-fold increase. Monoliths with dramatically increased surface areas may be used for the high surface area energy chips described herein, where the average pore size may be controlled to be about 5 nm or smaller, or about 3 nm or smaller.

Thus, a surface area of the open pore network in the monoliths may be about 50 m²/g to about 5000 m²/g, or even higher, e.g., at least about 50 m²/g, at least about 100 m²/g, at least about 150 m²/g, at least about 200 m²/g, at least about 300 m²/g, at least about 400 m²/g, at least about 500 m²/g, at least about 600 m²/g, at least about 700 m²/g, at least about 800 m²/g, at least about 1000 m²/g, at least about 1200 m²/g, at least about 1400 m²/g, at least about 1600 m²/g, at least about 1800 m²/g, at least about 2000 m²/g, at least about 2200 m²/g, at least about 2400 m²/g, at least about 2600 m²/g, at least about 2800 m²/g, at least about 3000 m²/g, at least about 3500 m²/g, at least about 4000 m²/g, at least about 4500 m²/g, or at least about 5000 m²/g.

The surface area of the nanoporous monolith may be measured a Non-Local Density Functional Theory (NLDFT) method as described in M. Thommes, “Physical Adsorption Characterization of Ordered and Amorphous Mesoporus Materials” in Nanoporus Materials: Science and Engineering, G. Q. Lu, X. S. Zhao, Eds., Imperial College Press, Chapter 11 (2004).

The following example is provided to illustrate but not limit the various embodiments.

### Example 1

The chemical composition and molar ratio of the sol gel solution prepared were 1 TEOS (tetraethyl orthosilicate), 2.25 (water), 0.075 HF (hydrofluoric acid) and 0.01 HCl (hydrochloric acid). These chemicals were mixed and then poured into the Teflon container 500 (9″ height, 5⅛″ inner diameter). A rigid and flat (3 mm thick, 5″ diameter) quartz plate was put into the container containing the sol gel solution. Then, 500 μm thick Teflon separator sheets 100 and Teflon well sheets 200 were stacked alternately one at a time. To ensure equally distributed pressure and the flatness of the stacked Teflon mold, a quart plate 3 mm thick and 5″ in diameter were inserted in every 25 layers of stacked molds. About 200 pieces of each sheet 100 and sheet 200 were inserted into the container totaling 1400 pieces of monolithic nanoporous silica were produced in one batch. After the stacking processes were done, the bottom portion of filler 800 was placed on top of the stacked mold and then transferred the mold system into incubator chamber at 33° C. for aging up to 72 hours. During the aging time, pressure was applied by placing 140 lbs weight on top of the stacked mold. The weight was then removed and the mold system was transferred into an oven for drying at 160° C. under Nitrogen for up to 12 hours. After the drying step, the sample was then sintered in furnace at 840° C. for 1 hour with air purge. The resulting silica wafer had a surface area of 735.9 m²/g with average pore diameter of 4.89 nm and 63% of the pores in the resulting silica wafer were within 10% of the average pore diameter of 4.89 nm. A monolithic nanoporous silica having a thickness of 300 micron and a diameter of 23 mm was produced.

Although a feature may appear to be described in connection with a particular embodiment, one skilled in the art would recognize that various features of the described embodiments may be combined. Moreover, aspects described in connection with an embodiment may stand alone. Each publication and patent application cited in the specification is incorporated herein by reference in its entirety as if each individual publication or patent application were specifically and individually put forth herein.

What is claimed is:

1. An apparatus for forming sol-gel derived monoliths, the apparatus comprising:
a first separating layer;
a first well layer disposed on the first separating layer, the first well layer having at least one well; and
a second separating layer disposed on the first well layer opposite the first separating layer, wherein the at least one well is covered by the first separating layer and the second separating layer.

2. The apparatus of claim 1, wherein the at least one well in the first well layer is filled with a gel formulation.

3. The apparatus of claim 1, wherein the separate layer and well layer are made of hydrophobic low-friction materials.

4. An apparatus for forming sol-gel monoliths, the apparatus comprising a plurality of a repeating unit, the repeating unit comprising:
a first separating layer; and
a first well layer disposed on the first separating layer, the first well layer having at least one well.

5. The apparatus of claim 4, wherein the apparatus comprising at least 200 of the repeating unit.

6. The apparatus of claim 4, wherein the at least one well in the first well layer is filled with a gel formulation.

7. The apparatus of claim 4, wherein the separate layer and well layer are made of hydrophobic low-friction materials.

8. A process for forming a dry gel monolith comprising:
(a) inserting a gel formulation into a container;
(b) inserting alternating separator and well layers, wherein the well layer has at least one well;
(c) applying pressure to the stack of layers;
(d) removing pressure when the gel formulation has gelled; and
(e) processing the gel to form a dry gel monolith.

9. A dry gel monolith formed by the process according to claim 8.

10. The dry gel monolith of claim 9, wherein the monolith has a thickness of about 300 μm or less.

11. The dry gel monolith of claim 9, wherein the thickness across different portions of the dry gel monolith varies by less than 10%.

12. A silica sol-gel derived monolith comprising an open network of pores having an average pore diameter between about 0.3 nm and about 30 nm, and wherein the monolith has a thickness of about 300 microns or less, and wherein the thickness across different portions of the monolith varies by less than 10% of the thickness.
